(19) United States
(12) Patent Application Publication
(10) Pub. No.: US 2021/0365937 A1
(43) Pub. Date: Nov. 25, 2021

(54) MANAGING A SMART CONTRACT IN REAL-TIME

(71) Applicant: Telefonaktiebolaget LM Ericsson (publ), Stockholm (SE)

(72) Inventors: Nanjangud Chandrasekhara Swamy NARENDRA, Bangalore (IN); Ramachandran KRISHNASAMY, Tamil Nadu (IN); Sambit NAYAK, Orissa (IN); SYED NADEEMULLA R., Bangalore (IN); Anshu SHUKLA, Bangalore (IN)

(21) Appl. No.: 16/963,349

(22) PCT Filed: Feb. 14, 2018
(86) PCT No.: PCT/IN2018/050074

§ 371 Date: Jul. 20, 2020

(51) Int. Cl. G06Q 20/38; G06Q 20/40; G06Q 50/18

(52) U.S. Cl. CPC G06Q 20/3825; G06Q 50/18; G06Q 20/4014; G06Q 20/3827

(57) ABSTRACT

It is provided a method for managing a smart contract in real-time. The method is performed in a contract manager and comprises the steps of: obtaining a base version of the smart contract between the supplier and a first purchaser; recommending amendments to the base version of the smart contract, based on historic contract compliance data of the supplier, wherein the historic contract compliance data is based on smart contracts with the supplier and a plurality of purchasers; receiving a signal indicating an agreed smart contract between the first purchaser and the supplier; receiving a real-time monitoring signal relating to a compliance of the supplier in relation to at least one condition of a smart contract between the supplier and a second purchaser; and recommending amendments to the agreed smart contract, based on the monitoring signal.

### TECHNICAL FIELD

The invention relates to a method, contract managers, a computer program and a computer program product for managing a smart contract in real-time.

### BACKGROUND

Smart Contracts have emerged as a viable computer-readable alternative to the traditional human-generated contracts among business entities. Compared to the traditional approach, which is human-generated (and therefore, error-prone and often messy), smart contracts are based on computer protocols that facilitate, verify, and/or enforce the negotiation or performance of a contract. Smart contracts can be specified via languages such as Solidity and eSML (eSourcing Markup Language). These smart contract specification languages, therefore, provide a means for the parties to jointly specify the terms and conditions of the smart contract, which could comprise: contractual conditions; exceptions & exception handling; payment and penalties in case of exceptions.

Current work on smart contract modelling has limited itself to providing language constructs to specify them in a manner that is easy and convenient for users to define the smart contracts in a relatively unambiguous manner.

However, deriving the terms and conditions in the smart contact still requires a significant manual effort.

### SUMMARY

It is an object of embodiments herein to provide machine based support to simplify determination of conditions of a smart contract in real-time.

According to a first aspect, it is provided a method for managing a smart contract in real-time. The method is performed in a contract manager and comprises the steps of: obtaining a base version of the smart contract between the supplier and a first purchaser; recommending amendments to the base version of the smart contract, based on historic contract compliance data of the supplier, wherein the historic contract compliance data is based on smart contracts with the supplier and a plurality of purchasers; receiving a signal indicating an agreed smart contract between the first purchaser and the supplier; receiving a real-time monitoring signal relating to a compliance of the supplier in relation to at least one condition of a smart contract between the supplier and a second purchaser; and recommending amendments to the agreed smart contract, based on the monitoring signal.

The method may further comprise the step of: adjusting a supplier score for the supplier based on the monitoring signal.

The agreed smart contract may be based on the amendments recommended to the base version of the smart contract.

The monitoring signal may be based on a sensor evaluating at least one condition of the smart contract between the supplier and the second purchaser.

In the step of receiving a monitoring signal, the at least one monitoring signal may contain at least one predefined parameter that determine quality of delivery, in accordance with the at least one condition.

In the step of receiving a monitoring signal, the at least one condition may be related to a delivery time.

In the step of receiving a monitoring signal, the at least one condition may be related to a route used for delivery.

The contract manager may be implemented in a plurality of edge servers utilising a distributed storage.

According to a second aspect, it is provided a contract manager for managing a smart contract in real-time. The contract manager comprises: a processor; and a memory storing instructions that, when executed by the processor, cause the contract manager to: obtain a base version of the smart contract between the supplier and a first purchaser; recommend amendments to the base version of the smart contract, based on historic contract compliance data of the supplier, wherein the historic contract compliance data is based on smart contracts with the supplier and a plurality of purchasers; receive a signal indicating an agreed smart contract between the first purchaser and the supplier; receive a real-time monitoring signal relating to a compliance of the supplier in relation to at least one condition of a smart contract between the supplier and a second purchaser; and recommend amendments to the agreed smart contract, based on the monitoring signal.

The contract manager may further comprise instructions that, when executed by the processor, cause the contract manager to adjust a supplier score for the supplier based on the monitoring signal.

The agreed smart contract may be based on the amendments recommended to the base version of the smart contract.

The monitoring signal may be based on a sensor evaluating at least one condition of the smart contract between the supplier and the second purchaser.

The at least one monitoring signal may contain at least one predefined parameter that determine quality of delivery, in accordance with the at least one condition.

At least one condition may be related to a delivery time.

At least one condition may be related to a route used for delivery.

The contract manager may be implemented in a plurality of edge servers utilising a distributed storage.

According to a third aspect, it is provided a contract manager comprising: means for obtaining a base version of the smart contract between the supplier and a first purchaser; means for recommending amendments to the base version of the smart contract, based on historic contract compliance data of the supplier, wherein the historic contract compliance data is based on smart contracts with the supplier and a plurality of purchasers; means for receiving a signal indicating an agreed smart contract between the first purchaser and the supplier; means for receiving a real-time monitoring signal relating to a compliance of the supplier in relation to at least one condition of a smart contract between the supplier and a second purchaser; and means for recommending amendments to the agreed smart contract, based on the monitoring signal.

According to a fourth aspect, it is provided a computer program for managing a smart contract in real-time. The computer program comprises computer program code which, when run on a contract manager causes the contract manager to: obtain a base version of the smart contract between the supplier and a first purchaser; recommend amendments to the base version of the smart contract, based on historic contract compliance data of the supplier, wherein the historic contract compliance data is based on smart contracts with the supplier and a plurality of purchasers; receive a signal indicating an agreed smart contract between the first purchaser and the supplier; receive a real-time monitoring signal relating to a compliance of the supplier in relation to at least one condition of a smart contract between the supplier and a second purchaser; and recommend amendments to the agreed smart contract, based on the monitoring signal.

According to a fifth aspect, it is provided a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic drawing illustrating an environment in which embodiments presented herein can be applied;

FIG. 2 is a schematic diagram illustrating a software architecture of the contract manager of FIG. 1 comprising a number of software components, according to one embodiment;

FIGS. 3A-B are flow charts illustrating embodiments of methods for managing a smart contract in real-time, performed in a contract manager;

FIG. 4 is a schematic diagram illustrating components of the contract manager of FIG. 1;

FIG. 5 is a schematic diagram showing functional modules of the contract manager of FIG. 1 according to one embodiment; and

FIG. 6 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

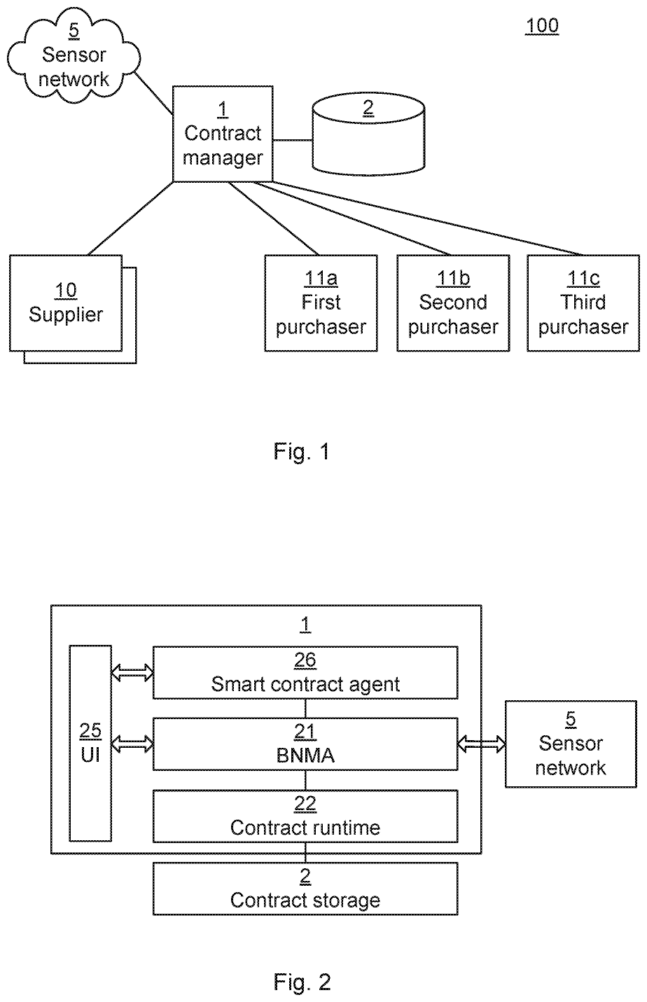

FIG. 1 is a schematic drawing illustrating an environment 100 in which embodiments presented herein can be applied. A contract manager 1 is used to manage smart contracts. The contract manager 1 utilises a contract storage 2 for storing and reading details about the smart contracts. The contract manager 1 can be implemented as a server. For instance, the contract manager 1 can be implemented in a plurality of edge servers, in which case the contract storage 2 is implemented using distributed storage.

One or more suppliers 10 are connected to the contract manager 1. Furthermore, in the example shown in FIG. 1, there is a first purchaser 11a, a second purchaser 11b and a third purchaser 11c. There can be fewer or more purchasers. Each supplier offers to deliver one or more product and/or one or more services. Each purchaser is interested in at least one product or service. A smart contract is associated with at least one supplier and at least one purchaser.

The contract manager 1 is also connected to a sensor network 5, comprising a plurality of sensors which can be used to monitor supplier compliance to conditions of a smart contract. Conditions are sometimes also referred to as terms, but for clarity only the term condition is used herein. An example related to food delivery can contain a set of conditions is deliver 50 kg of onions within 3 days. Another example of a condition is deliver high quality onions with not more than 5% of them gone bad, which can be usually measured using chemical sensors. The sensors of the sensor network 5 can be Internet of Things (IoT) sensors and/or other types of sensors.

FIG. 2 is a schematic diagram illustrating a software architecture of the contract manager 1 of FIG. 1 comprising a number of software components, according to one embodiment. The contract manager 1 comprises four software components: a smart contract agent 20, a business network model agent (here denoted BNMA), a contract runtime module 22, and a user interface (UI) module 25. Closely related to the contract manager 1 is the contract storage 2. The contact storage 2 optionally forms part of the contract manager 1.

The smart contract agent 20 is responsible for user account management, service management and smart contract management. The BNMA 21 provides a proxy for the parties in the smart contract to enact and monitor the contract policies. The contract runtime module 22 is responsible for individual smart contract deployment, managing the local contract data and establishing consensus for transactions in the smart contract.

The UI module 25 provides a UI, e.g. using a web interface, allowing client devices of users to connect to the contract manager 1, thereby enabling user interaction with the contract manager.

The software components are designed in such a way that they can be distributed and cloud agnostic, e.g. to be implemented in edge servers.

The smart contract agent 20 acts as a server module that enables registration of user account and service management capabilities via ReST APIs (Representational State Transfer Application Programming Interfaces) from the UI module 25. A user can be registered in the contract manager as a purchaser or as a supplier. This server module further provides a platform to the purchaser and supplier to collaborate for a business case and negotiate the business values, i.e. conditions, to setup a smart contract which is mutually beneficial. Once the contract is signed by both parties, the contract manager 1 deploys the smart contract in the contract runtime module 22, which e.g. can be implemented using Ethereum Virtual Machine (EVM). The negotiated smart contract forms the business process to be followed for achieving successful business between the purchaser and supplier, establishing trust between them using the contract manager 1.

The smart contract agent 20 then deploys the BNMA 21, which is a proxy agent for each of the parties in the contract (typically a purchaser and a supplier) upon successful contract deployment. The BNMA is responsible for extracting a local contract copy, establishing communication endpoints, executing the contract steps, monitoring contract violations and/or successful contract condition delivery and trigger registered software handlers to handle any contract violation/deliveries in accordance with the agreed smart contract. The negotiated contract conditions can require monitoring of physical state of goods to be delivered (e.g. perishable food items) in the smart contract in terms of its quantity, quality, and delivery location. Alternatively contract conditions can relate to IT services to be provided, in terms of delivery time, cost, etc. Monitoring of contract conditions can be implemented using the sensor network 5. Furthermore, real-time data can be collected and compared with conditions of the current smart contract using the sensor network 5 and BNMA 21. Real-time data relates to the contract execution, for instance is the estimated time of arrival of onions in accordance with an agreed schedule, and is the quality of the onions being maintained during transit?

The BNMA 21 can also be programmed to enable payment methods upon successful business delivery, e.g. in terms of traditional payment gateway or using cryptocurrencies such as Ether, Bitcoin etc. Hence, the BNMA 21 can replace human entities to handle the contract enactment and contract condition enforcement, thereby automating the process.

The smart contract runtime module 22 stores contract runtime data in the contract storage 2, e.g. in a local and/or distributed storage database. Consensus data for every transaction is stored in association with its smart contract in a consensus database of the contract storage 2. Consensus data refers to overall execution data pertaining to the smart contract. In the food delivery example, this can relate to how the onions were delivered, in what condition, and whether they were delivered on time. The consensus database can be a local database and/or it can be implemented using a distributed ledger stored in a blockchain so that the transactions are protected and audited by its distributed and immutable nature.

The UI module 25 provides the graphical user interface to the users, for accessing the smart contract agent 20 and to communicate with end users. The UI module 25 can be implemented using a form based web page navigation, to enable the user to perform the following tasks:
to register users and services in the contract manager 1
to query a dynamic list of suppliers for a given service type
to select a potential supplier and negotiate new contract conditions and establish the smart contract
to query status of a specific smart contract and to view contract runtime data, displayed in a graphical and user friendly model.

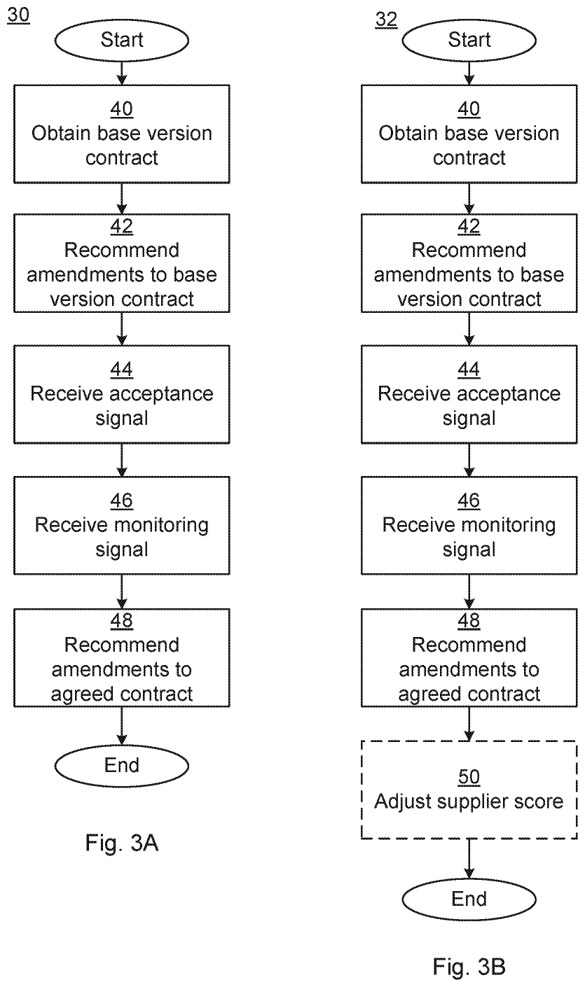

FIGS. 3A-B are flow charts illustrating embodiments of methods for managing a smart contract in real-time, performed in a contract manager. The methods 30 and 32 implement functions of components of the contract manager 1 in the environment 100 as described above with reference to FIG. 1 and FIG. 2. As described above, the contract manager 1 can be implemented in a plurality of edge servers utilising a distributed storage.

The methods implement learning based dynamic smart contract management between the purchaser and the supplier. This solution can be applied for any type of smart contract, e.g. for purchase of goods, services, IT service, exports, asset management, lease management etc.

In an obtain base version contract step 40, the contract manager 1 obtains a base version of a smart contract between the supplier 10 and a first purchaser 11a.

The base version contract can e.g. be obtained by reusing an earlier contract between the first purchaser 11a and the supplier 10, or by asking the purchaser 11a to select a prior contract and tweak it accordingly.

In a recommend amendments to base version contract step 42, the contract manager 1 recommends amendments to the base version of the smart contract.

The recommendation is based on historic contract compliance data of the supplier. The historic contract compliance data, in turn, is based on smart contracts with the supplier 10 and a plurality of purchasers (11a-c). In other words, the historic contract compliance data can contain compliance history with the supplier 10 also with other purchasers, see e.g. the second purchaser 11b of FIG. 1 and the third purchaser of FIG. 1.

It is the smart contract agent (20 of FIG. 2) that recommends amendments to the smart contract based on the past history of the supplier 10.

For instance, if the supplier 10 has a history of delivering late, the smart contract engine 20 can recommend significant penalties if the delivery is late.

In a receive acceptance signal step 44, the contract manager 1 receives a signal indicating an agreed smart contract between the first purchaser 11a and the supplier 10. In other words, when the purchaser and supplier of a smart contract agree on a smart contract with all its conditions, the smart contract is an agreed smart contract.

The acceptance signal can e.g. be received using the UI (25 of FIG. 2) when a human operator of the purchaser indicates that a smart contract has been agreed.

When this step is performed, the contract manager 1 knows that the first version of the smart contract is agreed.

In a receive monitoring signal step 46, the contract manager 1 receives a real-time monitoring signal relating to a compliance of the supplier 10 in relation to at least one condition of a smart contract between the supplier 10 and a second purchaser 11b.

The monitoring signal can be based on a sensor evaluating at least one condition of the smart contract between the supplier 10 and the second purchaser 11b, as described below.

The at least one monitoring signal can contain at least one predefined parameter that determine quality of delivery (of the goods and/or services of the smart contract), in accordance with the at least one condition.

The at least one condition can be related to a delivery time, which can be monitored by a sensor device monitoring the location of the goods to be delivered. Additionally or alternatively, the at least one condition can be related to quality of delivery. Additionally or alternatively, the at least one condition can be related to a route used for delivery. The route can be monitored by a sensor device monitoring the location of the goods to be delivered.

Hence, when smart contract fulfilment requires the shipment of physical goods, then sensors (IoT-based and other) can be used to track the progress of the shipment. The exact type of sensor to be used depends on the nature of the good being shipped and the condition to be monitored. One example of when the service of the smart contract is an IT service is the delivery of cloud services, such as streaming video.

In the contract manager 1, the smart contract agent (20 of FIG. 2) is responsible for modelling sensor requirements based on user inputs. That is, the user can, in the course of defining the smart contract, also specify the sensors that will track fulfilment of the smart contract, as well as a contract acceptable (and/or contract violating) value range for each sensor. The value range provides an indication of the extent of fulfilment (or lack thereof) of the smart contract via shipment. The sensor network periodically transmits sensor values in real-time data to the smart contract agent (20 of FIG. 2), which compares the sensor values to acceptable and/or violating value ranges.

In a recommend amendments to agreed contract step 48, the contract manager recommends amendments to the agreed smart contract, based on the monitoring signal. This implements a dynamic learning of contract compliance and managing the smart contracts at real-time.

As explained above, real-time data is extracted from monitoring signals for contracts for potentially a plurality of purchasers (11 a-c) for each supplier 10. The contract manager 1 can be implemented using distributed edge servers that receive monitoring data from distributed sensors networks tracking the progress of currently running smart contracts that involve the supplier. Which data to form part of the monitoring data is derived from the conditions of the smart contract in question. This monitoring data is evaluated by the contract manager to thereby recommend one or more amendments to the agreed smart contract.

Looking now to FIG. 3B, only new or modified steps compared to the steps of FIG. 3A will be described.

In an adjust supplier score step 50, the contract manager 1 adjusts a supplier score for the supplier 10 based on the monitoring signal.

Based on the information received from the sensors 5, the contract manager 1 recalculates the reliability of the supplier in question, and updates the supplier score. In one embodiment, the supplier score is a relative ranking that continuously ranks the supplier in question vis-à-vis its competing suppliers in terms of how well/badly it is fulfilling its smart contracts.

The monitoring data mentioned above can be used to update the supplier score in real-time, since sensor networks can be built for rapid data distribution. Additionally, a user interface 25 can be used to allow human operators of the smart contract manager to provide smart contract monitoring data in accordance with observations and evaluations of the human operator. Human operators can also provide predictions of how well/badly the smart contract in question will be fulfilled, and this can also be used by the contract manager 1 to update the supplier score.

The supplier score can be presented to human operators of the smart contract manager to support the selection of supplier, e.g. in conjunction with step 40 mentioned above.

An example will now be presented to illustrate the supplier score. In this example, at time T1, purchaser A requests the contract manager 1 to provide a list of suppliers 10 for a particular service, sorted by supplier scores, high to low. The contract manager 1 responds with three suppliers X, Y & Z with supplier scores associated with one or more of their service attributes (e.g. product freshness and delivery time) as 80, 70 & 50 respectively from its database. Here, supplier X seems to be at best potential to deliver the order for purchaser A. At time T2 such that T1<T2, supplier Y successfully delivers the order with high quality in accordance with another contract, for purchaser B, which has the effect that the supplier increases score by 10. The supplier score increases to 80. Furthermore, supplier X happens to violate the clause with respect to the freshness of the item, as the freshness index received from the real-time sensor is less than the negotiated minimum freshness index value on his current executing contract with purchaser C. This results in a penalty action kicking in for supplier X, and the supplier score is reduced to 75 from 80. Now, at time T3 such that T2<T3, purchaser A requests the list of suppliers from the contract manager 1, which results in a list with suppliers Y, X and Z with supplier scores 80, 75 and 50 respectively.

Now, purchaser A can either decide to select supplier Y as the contract partner, since supplier Y has the highest supplier score or he can still stick with supplier X, negotiating additional penalty clause and/or requesting a lower price, allowing purchaser A to achieve better conditions, trying to ensure the quality of delivery with more stringent penalty clause to avoid the same thing happening to purchaser A that happened to purchaser C.

Now assume purchaser A selects supplier Y and enters into a contract. At time T4 such that T3<T4, the contract manager 1 reduces the supplier score for supplier Y based on real-time data received from the sensor network for the product freshness, in relation to negotiated conditions in a smart contract with purchaser D. The penalty results in the supplier score for supplier Y being reduced to 75. The contract manager 1 then notifies the adjusted supplier score to purchaser A who is running an active contract with the same supplier Y. Based on the severity of the contract conditions, purchaser A can either renegotiate modified conditions based on the current state of the contract, to levy more penalty in case of contract violation, or he can terminate the contract and negotiate a fresh contract with a different supplier following the same process as discussed earlier. This helps the purchaser to mitigate the risk or have proper contingency methods in place to handle any future contract violations or business failures proactively based on the real-time data.

In order to illustrate embodiments herein, another example is now presented, involving an embodiment applied to logistics management.

In this example, purchaser A asks the contract manager 1 to suggest a list of suppliers for moving goods, e.g. furniture and other items. The contract manager i suggests the top N suppliers based on the supplier scores of the suppliers calculated based on contract compliance history. Now purchaser A negotiates with supplier-1, with conditions related to packaging, orientation and delivery, resulting in a first version of the smart contract. After agreement between purchaser A and supplier-1, supplier-1 installs sensors and actuators stipulated by the smart contract, such as a vibration sensor, an orientation sensor/actuator and a GPS (Global Positioning System) device for location and route selection etc. The supplier-1 then initiates the movement, thus executing the contract.

Optionally, purchaser A can negotiate with supplier-1 for any modification in the negotiated value for any of the negotiated contract conditions in order to accept a second version of the contract. This is possible if the contract manager 1 is able to adopt or fulfil the change based on the current execution state of the contract. Otherwise, the proposal will be rejected and the contract manager 1 continues to execute the first version of the smart contract.

Now let's say based on the real-time value received from the GPS device, the selected route delay happens to deviate more than what is stated in a condition of the contract, whereby contract violation logic (which depends on the smart contract) kicks in and suggests to select an alternative route as negotiated, and proposes a change in the delivery time to purchaser A. This results in an updated third version of the contract. Execution of the service according to the contract continues. The contract manager 1 further applies any penalty for supplier-1 for the contract violation (delay in delivery time in this case) and modifies the supplier score of supplier-1 accordingly. Finally, when the goods are delivered at the destination, the contract manager 1 compares the final value of all the contract conditions with the negotiated values and closes the contract gracefully after successful payment from purchaser A to supplier-1.

This example illustrates one possible deployment of the contract manager for the logistics use case at high level. The contract conditions and the sensor types mentioned in the example are just examples, as it is application specific on what type of data is negotiated and exchanged in the smart contract and its associated IoT network.

The embodiments presented herein provide a generic platform for negotiating and executing the smart contracts and reacting to the real-time monitoring values of the negotiated contract conditions at runtime to fine tune the contract conditions, to thereby increase success rates of contract compliance. Moreover, the suppliers are evaluated, assisting a purchaser in terms of better supplier selection, which is based on the historic contract compliance for a given service type. Embodiments presented herein can be applied in a wide range of situations, such as supply chain management, asset management, renewable energy sharing, tenant management for cloud based solutions, logistics management etc., but is not limited to the named examples.

Embodiments presented herein are particularly applicable for distributed IoT (Internet of Things) cloud systems. Such systems are characterised by one or more of the following:
High velocity short term contracts, typically for access to data and/or services
Large number of such short term contracts
Need for rapid transfer of payment in tune with short term duration of contracts
Need for rapid rollback in case one or more of the parties wants to break the contract

This is supported by the presented embodiments, providing rapid and automated smart contract generation. Furthermore, the dynamic learning-based approach provided allows rapid selection and adjustment of and conditions of smart contracts before presenting them to a human operator of the smart contract manager for approval.

Embodiments presented herein enable selection of smart contracts based on a precise analysis of the conditions affecting the compliance of the smart contract. Moreover, the dynamic learning-based approach informs the tailoring of the smart contract before being approved, thereby improving accuracy of the smart contract once it is approved by human operators.

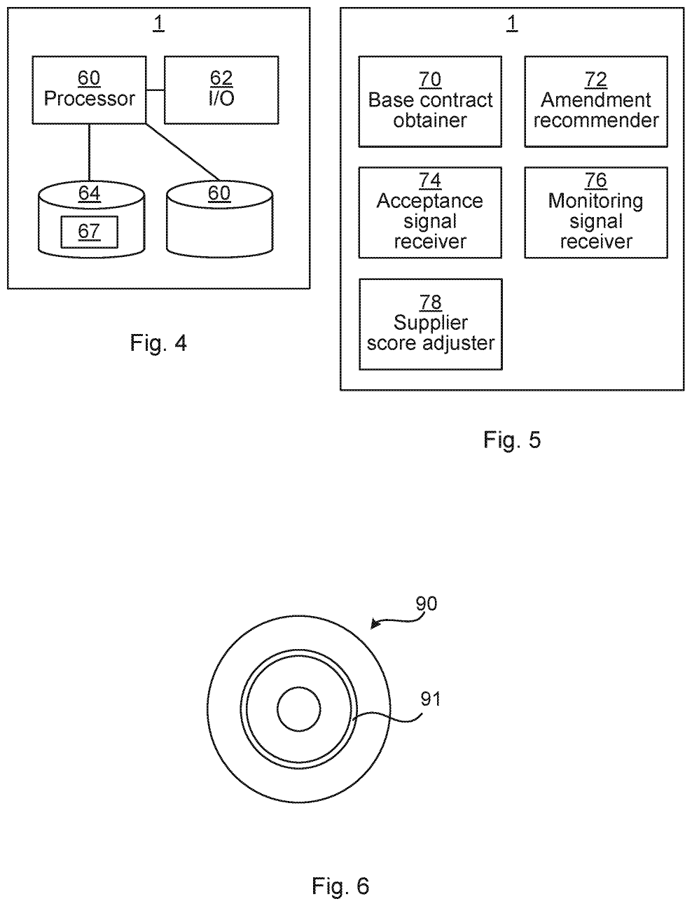

FIG. 4 is a schematic diagram illustrating components of the contract manager 1 of FIG. 1. A processor 60 is provided using any combination of one or more of a suitable central processing unit (CPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A and 3B above.

The memory 64 can be any combination of random access memory (RAM) and/or read only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or persistent storage, which, for example, can be any single one or combination of magnetic memory, optical memory, solid-state memory or distributed memory.

The contract manager 1 further comprises an I/O interface 62 for communicating with other external entities.

Other components of the contract manager 1 are omitted in order not to obscure the concepts presented herein.

FIG. 5 is a schematic diagram showing functional modules of the contract manager 1 of FIG. 1 according to one embodiment. The modules are implemented using software instructions such as a computer program executing in the contract manager 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A-B.

A base contract obtainer 70 corresponds to step 40 of FIGS. 3A-B. An amendment recommender 72 corresponds to steps 42 and 48 of FIGS. 3A-B. An acceptance signal receiver 74 corresponds to step 44 of FIGS. 3A-B. A monitoring signal receiver 76 corresponds to step 46 of FIGS. 3A-B. A supplier score adjuster 78 corresponds to step 50 of FIG. 3B.

FIG. 6 shows one example of a computer program product 90 comprising computer readable means. On this computer readable means, a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 64 of FIG. 4. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1. A method for managing a smart contract in real-time, the method being performed in a contract manager and comprising:
obtaining a base version of the smart contract between the supplier and a first purchaser;
recommending amendments to the base version of the smart contract, based on historic contract compliance data of the supplier, wherein the historic contract compliance data is based on smart contracts with the supplier and a plurality of purchasers;
receiving a signal indicating an agreed smart contract between the first purchaser and the supplier;
receiving a real-time monitoring signal relating to a compliance of the supplier in relation to at least one condition of a smart contract between the supplier and a second purchaser; and
recommending amendments to the agreed smart contract, based on the monitoring signal.

2. The method according to claim 1, further comprising:
adjusting a supplier score for the supplier based on the monitoring signal.

3. The method according to claim 1, wherein the agreed smart contract is based on the amendments recommended to the base version of the smart contract.

4. The method according to claim 1, wherein the monitoring signal is based on a sensor evaluating at least one condition of the smart contract between the supplier and the second purchaser.

5. The method according to claim 1, wherein in the receiving a monitoring signal, the at least one monitoring signal contain at least one predefined parameter that determine quality of delivery, in accordance with the at least one condition.

6. The method according to claim 1, wherein in the receiving a monitoring signal, the at least one condition is related to a delivery time.

7. The method according to claim 1, wherein in the receiving a monitoring signal, the at least one condition is related to a route used for delivery.

8. The method according to claim 1, wherein the contract manager is implemented in a plurality of edge servers utilizing a distributed storage.

9. A contract manager for managing a smart contract in real-time, the contract manager comprising:
a processor; and
a memory storing instructions that, when executed by the processor, cause the contract manager to:
obtain a base version of the smart contract between the supplier and a first purchaser;
recommend amendments to the base version of the smart contract, based on historic contract compliance data of the supplier, wherein the historic contract compliance data is based on smart contracts with the supplier and a plurality of purchasers;
receive a signal indicating an agreed smart contract between the first purchaser and the supplier;
receive a real-time monitoring signal relating to a compliance of the supplier in relation to at least one condition of a smart contract between the supplier and a second purchaser; and
recommend amendments to the agreed smart contract, based on the monitoring signal.

10. The contract manager according to claim 9, further comprising instructions that, when executed by the processor, cause the contract manager to adjust a supplier score for the supplier based on the monitoring signal.

11. The contract manager according to claim 9, wherein the agreed smart contract is based on the amendments recommended to the base version of the smart contract.

12. The contract manager according to claim 9, wherein the monitoring signal is based on a sensor evaluating at least one condition of the smart contract between the supplier and the second purchaser.

13. The contract manager according to claim 9, wherein the at least one monitoring signal contain at least one predefined parameter that determine quality of delivery, in accordance with the at least one condition.

14. The contract manager according to claim 9, wherein the at least one condition is related to a delivery time.

15. The contract manager according to claim 9, wherein the at least one condition is related to a route used for delivery.

16. The contract manager according to claim 9, wherein the contract manager is implemented in a plurality of edge servers utilizing a distributed storage.

17. (canceled)

18. A computer program product for managing a smart contract in real-time, the computer program product comprising a non-transitory computer readable medium storing computer program code which, when run on a contract manager causes the contract manager to:
obtain a base version of the smart contract between the supplier and a first purchaser;
recommend amendments to the base version of the smart contract, based on historic contract compliance data of the supplier, wherein the historic contract compliance data is based on smart contracts with the supplier and a plurality of purchasers;
receive a signal indicating an agreed smart contract between the first purchaser and the supplier;
receive a real-time monitoring signal relating to a compliance of the supplier in relation to at least one condition of a smart contract between the supplier and a second purchaser; and
recommend amendments to the agreed smart contract, based on the monitoring signal.

19. (canceled)
